(19) United States
(12) Patent Application Publication
(10) Pub. No.: US 2007/0232716 A1
(43) Pub. Date: Oct. 4, 2007

(54) Cross-linking resins

(75) Inventors: Gerhard Guenther, Seabrook, TX (US); Lea Ann Nairn, League City, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 11/732,617

(22) Filed: Apr. 4, 2007

Related U.S. Application Data
(60) Provisional application No. 60/788,949, filed on Apr. 4, 2006.

(51) Int. Cl. C08J 3/28

(52) U.S. Cl. 522/150

(57) ABSTRACT

This invention relates polyethylene resins that are mixed with peroxides during extrusion to partially cross-link the polymer. The resins are then used to form an article and the article is then irradiated to cause further cross-linking of the polymer. Such resins are useful in blow molding applications, rotomolding, for foamed materials or articles, for extruded membranes, sheets and layers, and for applications where resins are wrapped around other materials or resins prior to irradiation. This cross-linking improves the properties of the resin for certain end-use applications. The polyethylene resins can be obtained from chromium catalyzed polymerizations, Ziegler-Natta catalyzed polymerizations, and metallocene polymerizations.

### RELATED APPLICATIONS

The present application claims priority to U.S. Provisional Application No. 60/788,949, filed Apr. 4, 2006 and entitled “Improved Crosslinking Resins,” which is fully incorporated herein by reference.

### TECHNICAL FIELD

The invention relates generally to the polyolefin polymers or copolymers that are with peroxides during extrusion to partially cross-link the polymer, then formed into an article that is further cross-linked by radiation. This cross-linking improves the properties of the resin for certain end-use applications.

### BACKGROUND

Polyolefin resins such as polyethylene are used to produce a wide variety of articles used by consumers and in industry. This invention relates to the production of polyethylene resins, and particularly, to polyethylene resins that are mixed with peroxides during extrusion to partially cross-link the polymer. The resins are then used to form an article and the article is then irradiated to cause further cross-linking of the polymer. The physical and chemical characteristics of the polymers are changed by such cross-linking. Such resins are useful in blow molding applications, thermoforming, to produce foamed materials or articles, in extrusion and coextrusion, rotomolding, and in applications where resins are wrapped around other materials or resins.

The polyethylene resins that are used in these processes can be obtained from chromium-catalyzed polymerizations, Ziegler-Natta catalyzed polymerizations, and metallocene polymerizations.

### SUMMARY

Disclosed is a method of cross-linking polyethylene resins to improve the properties thereof including: producing a resin comprised of an ethylene polymer, adding at least one peroxide during extrusion to cause a first cross-linking of the polyethylene, forming an article, and irradiating the article to cause additional cross-linking of the polyethylene. Also disclosed is a method of forming an article with a cross-linked polyethylene, that includes producing a resin comprised of an ethylene polymer, adding at least one peroxide during extrusion to cause a first cross-linking of the polyethylene, forming an article, and then irradiating the article to cause additional cross-linking of the polyethylene comprising the article.

The ethylene polymer that is cross-linked is a homopolymer or a copolymer. In an aspect, the ethylene polymer is a copolymer with an ethylene content of from about 90 to about 100 mol %, with the balance being made up of a C₃-C₁₀ alpha olefin. In an aspect, the peroxide is selected from the group consisting of a dialkyl peroxide, a t-butyl peroxide, a t-amyl peroxide, and combinations thereof. In an embodiment, the article includes a molded article, a blow-molded article, a foamed article, an extruded article, a coextruded article, a rotomolded article, a thermoformed article, and a combination thereof. The formed article can then be irradiated and may also be wrapped with a film or a sheet before the irradiation.

In an aspect, the polymer is irradiated until a predetermined radiation dose has been absorbed. In an embodiment, the article travels through an apparatus during irradiation.

Also disclosed is an article formed by the foregoing methods.

### DETAILED DESCRIPTION

It has been found that the properties and processability of polyethylene can be achieved by adding a free radical initiator to the polyethylene during extrusion to cause the addition of long-chain branching and/or cross-linking. by.

The polyethylene may be homopolymers or copolymers of ethylene and C₃-C₁₀ alpha-olefin monomers. When copolymers are used, the ethylene content will typically range from about 90 to about 100 mol %, with the balance typically being made up of the C₃-C₁₀ alpha olefin. The copolymer resin may also be comprised of styrene or an elastomer. The invention has particular application in increasing the rheological breadth of polyethylene resins having a narrow molecular weight distribution (MWD), which can be used in blow molding and other end use applications. Narrower MWD polyethylenes are typically used for film, sheet, fiber and injection molding applications where melt strength and processability is sacrificed for certain solid state properties and aesthetics. Broad MWD distribution resins are typically used in applications where melt strength, processability and solid state performance such as stress crack resistance are desired such as blow molding and pipe applications. The MWD can be described by means of the curve obtained by gel permeation chromatography. Also, the MWD is generally described by what is known as the polydispersity index (D), which represents the ratio between the weight-average molecular weight and the number-average molecular weight (M_{w}/Mₙ), as defined by standard and well-known GPC or SEC methods.

The polyethylene used in this invention can be produced from a variety of catalysts capable of producing the desired molecular weight distribution. The chromium catalysts that are used are those that are well known to those skilled in the art. Activated chromium catalysts on a silica or titanium oxide support are particularly well-suited to the polymerization of ethylene for blow molding resins. Increased rheological breadth of polyethylene produced from other catalysts used in the polymerization of olefins, such as Ziegler-Natta, metallocene or late-transition metal catalysts can be obtained as well. The metallocene catalysts produce polyethylene with a narrower molecular weight distribution, compared to Ziegler-Natta catalysts that produce polyethylene with a higher, but medium molecular weight distribution, with the chromium catalysts producing polyethylene with the highest molecular weight distribution.

The molecular weight density (MWD)/polydispersity of the polymers that can be used in this invention may also depend upon the type of catalyst used to produce the polymer. For example a metallocene produced unimodal or bimodal polyethylene resin may have a MWD of from 2 to 4, while a Ziegler-Natta catalyzed polyethylene resin may have a MWD of from 4 to 10 for unimodal resins and a MWD of from 10 to 25 for bimodal resins, with a unimodal chromium catalyzed polyethylene resin having a MWD of from 6 to 25. The MWD of a polyethylene polymer impacts the melt flow index of the polymer.

Without limiting the scope of the aforementioned types of polyethylene resins that can be used in this invention, specific examples of types of polyethylene resins that can be used for such applications include, by way of example U.S. Pat. No. 5,486,575 to Shroff entitled “High Performance Blow Molding Resins and Process for Their Preparation,” which is fully incorporated by reference herein, but which is modified with Applicants' invention.

Polyethylene resins produced with Ziegler-Natta catalysts can be modified through the use of cross-linking agents such as peroxides, to improve the polymer properties and increase efficiency of treatment with electron beams (e-beams), such as, for example those disclosed in U.S. Pat. No. 5,962,598 to Mack et al., entitled Polyethylene Film Composition Having Broad Molecular Weight Distribution and Improved Bubble Stability, and U.S. Pat. No. 6,433,103 to Guenther et al., entitled Method of Producing Polyethylene Resins for Use in Blow Molding.

Metallocene catalysts and catalyzed resins that may be useful in this application include by way of example, Shamshoum et al. U.S. Pat. No. 6,225,251, entitled Catalyst Efficiency For Supported Metallocene Catalyst; Gauthier et al. U.S. Pat. No. 6,777,366 and U.S. Pat. No. 6,777,367, both entitled Method For The Preparation of Metallocene Catalysts, all of which are fully incorporated by reference herein, with one or more of the foregoing being modified by peroxides added to resin master batches during extrusion, followed by irradiation after an article has been formed. Also, metallocene resins disclosed in U.S. Pat. Nos. 6,433,103 and 6,706,822, both entitled Method of Producing Polyethylene Resins for use in Blow Molding, and 6,984,698 entitled Polyethylene Films for Barrier Applications all by Guenther, et al., all of which are fully incorporated by reference herein, can be used in this invention.

Further types of polyethylene resins that can be produced by the following methods can also be used in this invention, with peroxides being added during extrusion and then treatment with e-beams or other radiation occurring: U.S. application Ser. No. 11/119,265, entitled “Polyethylene Useful for Blown Films and Blow Molding”; U.S. application Ser. No. 10/685,853, entitled “Polyethylene Films for Barrier Applications”; U.S. application Ser. No. 11/019,060, entitled “Blends of Medium Density Polyethylene with Other Polyolefins”; U.S. application Ser. No. 11/471,997, entitled “Cocatalysts Useful for Improving Polyethylene Film Properties”; U.S. application Ser. Nos. 11/174,815 and 11/267,984, entitled “Methods for Controlling Polyethylene Rheology”; U.S. application Ser. No. 11/281,129, entitled “Polymeric Film Structures and Compositions for High Surface Treatment Retention”; U.S. Pat. No. 6,433,103, entitled Method of Producing Polyethylene Resins for Use in Blow Molding, and U.S. Pat. No. 6,930,137, entitled “Method of Improving Blown Film Processing Performance and Physical Properties”, all of which are fully incorporated by reference herein.

In a further embodiment, commercially available master batch resins can be mixed with the chosen peroxide during extrusion and then irradiated, including but not limited to Total Petrochemicals polyethylene resins as well as other commercially available polyethylene resins from any source made by the Phillips slurry loop process. Also resins made by Solvay, such as B53-35H-011, B53-35H-001, B50-20H-127, and Chevron resins 9406 and 9413 can be used. Unimodal or bimodal polyethylene resins that are made by utilizing the Phillips Loop, Hoechst CSTR technology or Mitsui polymerization technology are also suitable for use in this invention, as well as any other polyethylene resins made by other technologies.

A method for processing polyolefin resins such as polyethylene resins is provided. The method comprises selecting a first polyethylene resin having a fluff (initial) melt index that provides a desired final melt index after extrusion of the selected polyethylene resin. In order to accomplish this, an unmodified polyethylene resin typically used for blow molding applications, for example, having the desired properties or characteristics, such as a final melt index upon extrusion and/or blow molding was used as a standard and was modified by a selected amount of free radical initiator. The first polyethylene resin is modified during extrusion with a selected amount of a free radical initiator so that the first polyethylene resin is modified to provide a modified melt index of the first polyethylene resin that in some embodiments is different from the desired final melt index after extrusion. Alternatively, the unmodified first polyethylene resin and the modified second polyethylene resin may have final melt indices after extrusion that are substantially the same. The second polyethylene resin is selected to have a desired initial/fluff melt index based upon the differences between the modified melt index and the desired final melt index to provide a second desired final melt index. The desired initial melt index may be less or greater than the initial melt index of the first polyethylene resin, and the modified second polyethylene resin may have a greater rheological breadth compared to the first polyethylene resin upon extrusion. This second polyethylene is modified with the free radical initiator while the second polyethylene resin is in a molten state and extruded. The resultant polyethylene resin is then made into an article that is then treated with radiation such as one or more electron-beams (e-beams). The radiation treatment causes cross-linking and other changes in the resin.

In an embodiment, a free radical initiator is added to the polyethylene resin during extrusion. For example, air and oxygen may be used as the free radical initiator. The preferred free radical initiators, however, are peroxides, particularly the organic peroxides. The peroxides, as used herein, is that which results in light cross-linking or branching of the polyethylene molecules. When the cross-linking is moderate, it may also be referred to as long chain branching. Several classes of organic peroxides have been found to be particularly suitable. These are the dialkyl and peroxyketal type peroxides. Other examples of commercially available dialkyl peroxides suitable for use as free radical initiators are dialkyl peroxides 2,5-dimethyl-2,5-di(t-butylperoxy)hexane, available as LUPERSOL 101 and LUPERSOL 101PP20 from Arkema. Additionally, commercially available peroxyketal peroxides are LUPERSOL 233 and 533, which are examples of t-butyl and t-amyl type peroxides, respectively, and are also available from Arkema. Other dialkyl peroxides and t-butyl and t-amyl type peroxides can also be used as well as other peroxides known to one skilled in the art for cross-linking and/or long chain branching. The cross-linking of polymers by the addition of peroxides also improves electron-beam (e-beam) efficiency.

The peroxide may also be added or combined with the polyethylene prior to or after the polyethylene is fed into the extruder. The peroxide may be in solid or liquid form and may be introduced into the polyethylene through any means known to those skilled in the art, such as by means of a gear pump or other delivery device and then mixed into the polymer by means of a kneader such as a single screw extruder, a twin-screw extruder, a Banbury mixer, or another mixing apparatus known to one skilled in the art. In an embodiment, the peroxide mixing apparatus known to one skilled in the art. In an embodiment, the peroxide is added to the polyethylene fluff or powder during extrusion. In such cases, the peroxide should be thoroughly mixed or dispersed throughout the polymer before being introduced into the extruder. Alternatively, the peroxide can be injected into the polyethylene melt within the extruder. The peroxide is usually added as a liquid, although the peroxide may be added in other forms as well, such as a peroxide coated solid delivery. If oxygen or air is used as the initiator, these are preferably injected into the extruder within the polyethylene melt. In an embodiment, the extruder pressures for the modified polyethylene resin may be less than the extruder pressures for the unmodified polyethylene resin.

Of course other additives known to one skilled in the art can be used during original production of the resin as well as during extrusion, including but not limited to heat stabilizers, ultraviolet absorbers, antioxidants, colorings, fillers, antistatic agents, antimicrobial agents, lubricants, blocking resistants, slip and antiblock additives, other resins and the like, in suitable amounts.

In an embodiment, the polyethylene resins used with the present invention have a fluff melt index MI2 (MI using 2.16 kg-ASTM D1238, commonly referred to as MI2 or MI2.16) of from about 0.1 to about 10 dg/10 minute prior to extrusion, and in another embodiment from 2 to 7 dg/10 minute. For purposes of the present invention, all measurements of MI2.16 are in dg/10 minutes unless stated otherwise. In some embodiments, the polyethylene resins have an MI-2.16 of from about 0.3 to about 5 and, in other embodiments, from about 0.7 to about 3.0 prior to extrusion. After extrusion and peroxide addition, in an embodiment the polyethylene resins have an MI-2.16 of from about 0.05 to about 5, and in other embodiments have an MI-2.16 of from about 0.5 to about 3.

The amount of peroxide or other initiator necessary to achieve the desired properties and processability may vary. The amount of peroxide or initiator is important, in that too little will not achieve the desired effect, while too much may result in undesirable products being produced. In an embodiment when the free radical initiator is a peroxide, it will be incorporated into the linear polyethylene in a range of from 5 ppm to 200 ppm, or from 5 ppm to 100 ppm of active peroxide, in an additional embodiment from about 40 ppm to about 80 ppm, in other embodiments from 5 ppm to 70 ppm, 15 ppm to 50 ppm, or 35 ppm to 45 ppm, in yet further embodiments from 40 ppm to about 60 ppm, and in yet other embodiments from 60 ppm to about 80 ppm. The amount of the peroxide that is needed may also vary depending on the particular end use application (e.g. film versus blow molding). The amount of peroxide needed to achieve the desired properties will also depend upon the type of additive package used. In an embodiment, for a unimodal Ziegler-Natta catalyzed polyethylene such as Total Petrochemicals resin 6420, 35 ppm to 45 ppm of peroxide can be used for film, for example. In another embodiment, for a bimodal Ziegler-Natta catalyzed polyethylene used for film, 5 ppm to 15 ppm of peroxide can be used, and for blow molding, 40 to 50 ppm of peroxide can be used, for example.

In conducting the process of the present invention, the linear polymer or copolymer is melt extruded or pelletized at a temperature of at least 180° C., the temperature range being generally from about at least 180° C. to about 285° C., depending on the nature of the free radical initiator. If the initiator is a peroxide, the temperature will generally range from 180° C. to 205° C.

The choice of peroxide may vary depending upon the particular application and extruder temperatures encountered. Typical extruder temperatures are from about 350° F. to about 550° F. It is important that the extruder temperature or polyethylene melt be above the decomposition temperature of the peroxide. Thus, extruder temperatures will typically be at least 5% or higher than the decomposition temperature of the peroxide being used to ensure complete decomposition. The extruder temperature can be determined using a combination of peroxide half life versus temperature data and the residence time in the extruder as prescribed by the desired throughput.

The resin of this invention can be commercially produced with higher levels of long chain branching (i.e., cross-linking) via peroxide, air or extrusion conditions that would require less e-beam or peroxide when converting to a cross-linked final product. Appropriate additive packages will play a role as well in the physical and chemical characteristics. A peroxide master batch, e.g., PP carrier as is commercially available, can be used by before e-beam processes to reduce energy needed for cross-linking. This also can lead to shortened processing time and thus increased production. Other types of organic peroxides on other carriers can also be used such as silica and clay.

The additional of the peroxide causes a first cross-linking, and is followed by e-beam or other radiation treatment that causes a second cross-linking. The polymers of this invention can be irradiated by one or more of the methods and apparatus known to one skilled in the art for such purposes, including by way of example, U.S. Pat. No. 5,856,675, entitled “Method of Irradiation of Polymer Films by an Electron Beam” and U.S. Pat. No. 5,869,591, entitled “Thermoset Interpolymers and Foams”, both of which are fully incorporated by reference herein. Radiation is believed to effect cross-linking by generating polymer radicals that may combine and cross-link. Useful types of radiation types include but are not limited to electron beam or beta ray, gamma rays, X-rays, or neutron rays. In an embodiment, an article is formed before the polymer is irradiated because the radiation treatment changes the physical properties of the polymer and the polymer would be difficult or even impossible to process after it is irradiated if it is fully cross-linked. In such applications, cross-linking also imparts desirable physical properties to the final product. The improvements are also useful for increasing the stress crack resistance of molded or formed articles.

The required radiation dosage depends upon the composition of the polymer. Those skilled in the art will be readily able to select suitable radiation levels, taking into account such variables as thickness and geometry of the article to be irradiated, as well as to characteristics of the polymer, such as molecular weight, molecular weight distribution, comonomer content, the presence of cross-linking enhancing coagents, additives, etc.

In an embodiment, the radiation dosages such as by e-beams will be greater than about 5 Mrad (one million RADs) to about 80 Mrad. In another embodiment, the dosage is from about 15 Mrad to 20 Mrad. In an embodiment, an accelerated electron beam is used. In a further embodiment, the articles are gamma irradiated from 60 to 6000 kGy, in other embodiments from 50 to 300 kGy, and in still other embodiments 20 to 50 kGy. In an embodiment, the article is irradiated from 500 msec. to 2 sec., and in other embodiments from 2 seconds to 5 seconds, depending on external conditions (temperature, mechanical loads, and the like). The article can also be irradiated for other durations. The article is irradiated one or more times until the desired properties are obtained.

The resins of this invention are useful in blow molding applications, extrusion, co-extrusion, injection molding, thermoforming, rotomolding, and for applications where resins such as those in a sheet or film form are wrapped around other articles. A preformed article can be further cross-linked by subsequent radiation treatment. The resins of this invention are useful in blow molding applications, for producing foamed materials or articles, for extruded membranes, films, sheets and layers, fibers, and for applications where resins are wrapped around other materials or resins, for example.

Improvements in the processability of the polyethylene resins for use in blow molding applications to produce a final polyethylene product having desired melt properties was also achieved. This was accomplished by the addition of the free radical initiator agent to polyethylene having an initial polymer fluff or powder melt index that was higher than that normally used without modification by the addition of free radical initiator to provide the desired final melt index polymer. The increased melt index of the initial polyethylene and the increased rheological breadth of the pellets resulted in a polymer that could be used during extrusion and blow molding, providing lower extruder pressures and easier processability, while still obtaining polyethylene resins for blow molding with the desired final melt index and without any significant deterioration of the desired product characteristics. This was achieved while also obtaining reduced swell and improved color of the resultant polyethylene resin.

Improved or increased rheological breadth and improved swell for polyethylene resins having narrow molecular weight distributions were obtained for the given polyethylene resins. This was accomplished through the addition of a peroxide as the free radical initiator in appropriate amounts to achieve the increased rheological breadth. Improvements in other characteristics, such as color, were also observed.

### EXPERIMENTAL EXAMPLE

### Example 1

The addition of the free radical initiator in the form of a LUPERSOL peroxide to a Ziegler-Natta catalyzed polyethylene can be accomplished using a small Braebender PL-2000, or Plasti-Corder bench top twin screw extruder (Model D-6). Extrusion conditions were held constant at 40 RPM and a flat temperature profile of 215° C. from the feed section to the strand die was used to form an article. The article is then irradiated for further cross-linking of the polyethylene.

### Examples 2 and 3

Further examples of polyethylene resins that are modified by the addition of peroxides are set forth in U.S. Pat. No. 5,962,598 to Mack et al., entitled Polyethylene Film Composition Having Broad Molecular Weight Distribution and Improved Bubble Stability, and U.S. Pat. No. 6,433,103 to Guenther et al., entitled Method of Producing Polyethylene Resins for Use in Blow Molding.

These peroxide modified resins are then used to form an article that is irradiated to further cross-link the polyethylene.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

We claim:

1. A method of cross-linking polyethylene resins to improve the properties thereof comprising:
producing a resin comprised of an ethylene polymer;
adding at least one peroxide during extrusion to cause a first cross-linking of the polyethylene;
forming an article; and
irradiating the article to cause additional cross-linking of the polyethylene.

2. The method of claim 1, wherein the radiation comprises a beam of accelerated electrons.

3. The method of claim 1, wherein the peroxide is selected from the group consisting of a dialkyl peroxide, a t-butyl peroxide, a t-amyl peroxide, and combinations thereof.

4. The method of claim 1, wherein the article is selected from the group consisting of a molded article, an extruded article, a blow-molded article, a foamed article, a coextruded article, a rotomolded article, a thermoformed article, and a combination thereof.

5. The method of claim 4, wherein a formed article is wrapped with a film or a sheet comprised of polyethylene and is then irradiated.

6. The method of claim 5, wherein at least one peroxide is added to the polyethylene during the production of the film or the sheet to modify the polyethylene by cross-linking.

7. The method of claim 1, wherein the ethylene polymer is a homopolymer or is a copolymer.

8. The method of claim 1, wherein the ethylene polymer is a copolymer with an ethylene content of from about 90 to about 100 mol %, with the balance being made up of a C₃-C₁₀ alpha olefin.

9. An article formed by the method of claim 1.

10. A method of forming an article with a cross-linked polyethylene, comprising:
producing a resin comprised of an ethylene polymer;
adding at least one peroxide during extrusion to cause a first cross-linking of the polyethylene;
forming an article; and
irradiating the article to cause additional cross-linking of the polyethylene comprising the article.

11. The method of claim 10, wherein the article travels through an apparatus during irradiation.

12. The method of claim 10, wherein the article is selected from the group consisting of a molded article, a blow-molded article, a foamed article, an extruded article, a coextruded article, a rotomolded article, a thermoformed article, and a combination thereof.

13. The method of claim 12, wherein the formed article is wrapped with a film or a sheet and is then irradiated.

14. The method of claim 13, wherein at least one peroxide is added to the polyethylene during the production of the film or the sheet to modify the polyethylene by cross-linking.

15. The method of claim 10, wherein the ethylene polymer is a homopolymer or a copolymer.

16. The method of claim 10, wherein the ethylene polymer is a copolymer with an ethylene content of from about 90 to about 100 mol %, with the balance being made up of a C₃-C₁₀ alpha olefin.

17. The method of claim 10, wherein the radiation comprises a beam of accelerated electrons.

18. The method of claim 10, wherein the polymer is irradiated until a predetermined radiation dose has been absorbed.

19. The method of claim 10, wherein the peroxide is selected from the group consisting of a dialkyl peroxide, a t-butyl peroxide, a t-amyl peroxide, and combinations thereof.

20. An article formed by the method of claim 10.
